(19) United States
(12) Patent Application Publication
(10) Pub. No.: US 2023/0332903 A1
(43) Pub. Date: Oct. 19, 2023

(54) ROUTE PLAN GENERATION SYSTEM AND ROUTE PLAN GENERATION METHOD

(71) Applicant: TOYOTA JIDOSHA KABUSHIKI KAISHA, Toyota-shi Aichi-ken (JP)

(72) Inventors: Miki NOMOTO, Nagoya-shi Aichi-ken (JP); Yuka NISHIYAMA, Nagoya-shi Aichi-ken (JP); Kenichi OKUMURA, Gotemba-shi Shizuoka-ken (JP); Ryota TOMIZAWA, Mishima-shi Shizuoka-ken (JP); Tatsuya SUGANO, Sunto-gun Shizuoka-ken (JP); Yushi SEKI, Ashigarakami-gun Kanagawa-ken (JP); Tokuhiro MASUI, Nagoya-shi Aichi-ken (JP)

(73) Assignee: TOYOTA JIDOSHA KABUSHIKI KAISHA, Toyota-shi Aichi-ken (JP)

(21) Appl. No.: 18/115,281

(22) Filed: Feb. 28, 2023

(30) Foreign Application Priority Data
Apr. 18, 2022 (JP) 2022-068305

(51) Int. Cl. G06Q 50/12; G01C 21/34; A23L 3/36; G06Q 10/02; G01C 21/36

(52) U.S. Cl. CPC G01C 21/3415; A23L 3/363; G01C 21/3679; G06Q 10/02; G06Q 50/12; B60H 1/00878

(57) ABSTRACT

The route plan generation system generates a route plan for the movement of the user. The route plan generation system includes a user terminal operated by a user, a provider terminal, and a server. The provider terminal is operated by a food provider having a normal provision form of food and a temporary provision form. The server is connected to each of the user terminal and the provider terminal via a communication network. The route plan generation system executes a route plan change process of changing the route plan so that the provision place of the food pertaining to the offer of the offer is the destination or the via place, when the user requests the acquisition of the food pertaining to the offer of the offer of the food in response to the offer of the provision of the food in the temporary provision form from the food provider.

### CROSS-REFERENCE TO RELATED APPLICATION

This application claims priority to Japanese Patent Application No. 2022-068305 filed on Apr. 18, 2022, incorporated herein by reference in its entirety.

### BACKGROUND

### 1. Technical Field

The present disclosure relates to a route plan generation system and a route plan generation method for generating a route plan for movement of a user.

### 2. Description of Related Art

Japanese Unexamined Patent Application Publication No. 2019-160338 (JP 2019-160338 A) discloses a cancellation fee calculation device. The cancellation fee calculation device makes it possible to resell a part of a canceled service with respect to cancellation of a reservation of a restaurant or the like, requests another user for a re-reservation, and calculates a cancellation fee of the original user in consideration of a profit obtained by the re-reservation.

Japanese Unexamined Patent Application Publication No. 2021-039521 (JP 2021-039521 A) discloses an information processing device. The information processing device acquires information of a cooking class held in a vehicle and information of an ingredient providing source that provides ingredients used in the cooking class. Then, the information processing device executes matching between the cooking class and the ingredient providing source based on the acquired holding information and provision information, and determines ingredient procurement information to be notified to the ingredient providing source in response to the result of the matching.

### SUMMARY

The technique described in JP 2019-160338 A has the following problems when a user uses a route plan provided by a service such as mobility as a service (MaaS) for moving in traveling for tourism or the like. That is, when the user who uses the route plan obtains the information of the reservation cancellation of the restaurant and reserves the restaurant, it is necessary to change the destination in a hurry or to add the transit place in a hurry for the user to move to the reserved restaurant. The user must change the route plan by himself or herself. This is troublesome for the user.

The present disclosure provides a route plan generation system and a route plan generation method capable of reducing a user’s effort related to a route change caused by the user accepting a food provision offer from a food provider while moving and using a route plan.

A route planning generation system of generating a route plan for movement of a user according to the present disclosure includes: a user terminal operated by the user; a provider terminal operated by a food provider, the food provider having a normal provision mode of food and a temporary provision mode, in which the temporary provision mode is a mode that provides food that is no longer suitable for provision in the normal provision mode; and a server that is connected to the user terminal and the provider terminal via a communication network. When the user requests, in response to a provision offer of food in the temporary provision mode from the food provider, acquisition of food pertaining to the provision offer, the route plan generation system executes a route plan change process of changing the route plan such that a provision place of the food pertaining to the provision offer is a destination or a transit point.

In the route plan generation system according to the present disclosure, in a case in which the user requests to the acquisition of the food pertaining to the provision offer of when the user is using an autonomous vehicle that is able to perform unmanned traveling as a moving body for the movement, the route plan change process may include setting a travel plan of the autonomous driving vehicle such that the autonomous driving vehicle performs unmanned traveling to the provision place.

In the route plan generation system according to the present disclosure, in a case in which there is a vibration restriction of the food required during transportation of the food pertaining to the provision offer, when the autonomous vehicle performs unmanned traveling and brings back the food pertaining to the provision offer, the route plan generation system may cause the automatic vehicle to execute at least one of a vehicle control and a travel route selection for suppressing a vibration of a vehicle cabin of the autonomous driving vehicle.

In the route plan generation system according to the present disclosure, in a case in which there is a temperature condition of the food required during transportation of the food pertaining to the provision offer, when the autonomous vehicle performs unmanned traveling and brings back the food pertaining to the provision offer, the route plan generation system may cause the autonomous vehicle to execute a vehicle cabin temperature control of the autonomous vehicle for satisfying the temperature condition. In the route plan generation system according to the present disclosure, in a case in which the user or the food provider makes a request for antimicrobial treatment of the food pertaining to the provision offer or the food provider, when the autonomous vehicle performs unmanned traveling and brings back the food pertaining to the provision offer, the route plan generation system may operate an in-vehicle refrigerator that houses the food pertaining to the provision offer.

In the route plan generation system according to the present disclosure, the food provider may be a restaurant that provides food in a store as the normal provision mode. The temporary provision mode may be a mode in which excess food due to a reservation for eating and drinking in the restaurant is cancelled is provided.

A route plan generation method for generating a route plan for movement of a user according to the present disclosure includes: changing the route plan such that a provision place of food pertaining to a provision offer is a destination or a transit point, when the user requests acquisition of food pertaining to a provision offer in response to the provision offer of food in a temporary provision mode from a food provider. The food provider has a normal provision mode of food and a temporary provision mode of food that is no longer suitable for providing in the normal provision mode.

According to each of the route plan generation system and the route plan generation method according to the present disclosure, when the user requests to obtain the food pertaining to the provision offer in the temporary provision mode from the food provider, the route plan for movement of the user is automatically changed so that the provision place of the food pertaining to the provision offer is set as the destination or the transit point. Thus, it is possible to reduce a user’s effort related to a route change caused by the user accepting a food provision offer from a food provider while moving and using a route plan.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of a route plan generation system according to an embodiment;

FIG. 2 is a flowchart illustrating an example of a route plan change process and a process related thereto according to the embodiment;

FIG. 3 is a diagram illustrating another example of the configuration of the route plan generation system according to the embodiment;

FIG. 4 is a flowchart illustrating another example of a route plan change process and a process related thereto according to the embodiment;

FIG. 5 is a flow chart illustrating a process for a service provided during a user’s boarding when bringing food;

FIG. 6 is a flowchart showing a process related to a countermeasure against vibration of a food product during unmanned travel;

FIG. 7 is a flow chart illustrating a process for controlling the temperature of food during unmanned travel; and

FIG. 8 is a flow chart showing a process related to an antimicrobial measure of food being carried out in unmanned driving.

### DETAILED DESCRIPTION OF EMBODIMENTS

Hereinafter, embodiments of the present disclosure will be described with reference to the accompanying drawings. However, in the following embodiments, when the number of each element, the number, the quantity, the amount, the range, and the like are referred to, the technical idea according to the present disclosure is not limited to the number that has been referred to, except for the case where it is particularly explicitly indicated or the case where it is theoretically clearly specified by the number. In the drawings, the same reference numerals are assigned to the same elements, and redundant descriptions are omitted or simplified.

### 1. System Configuration

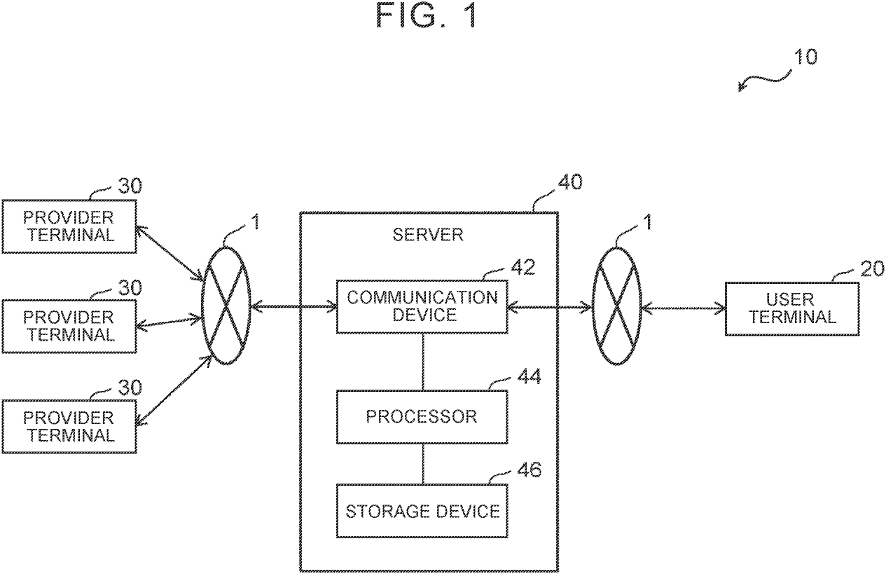

FIG. 1 is a diagram illustrating an example of a configuration of a route plan generation system according to an embodiment; The route plan generation system 10 illustrated in FIG. 1 generates a route plan for a user to move using Mobility as a Service (MaaS). “Movement” as used herein is, for example, a trip intended for tourism or the like. In other words, the route plan generation system 10 corresponds to a movement support system that supports movement of a user who uses the route plan.

The route plan generation system (hereinafter, sometimes simply referred to as “system”) 10 includes a user terminal 20, a provider terminal 30, and a server 40. As illustrated in FIG. 1, the number of provider terminals 30 is basically a plurality.

The user terminal 20 is operated by a user. The user uses the system 10 to move using MaaS. The user terminal 20 is, for example, a smartphone or a tablet personal computer. The user terminal 20 includes a processor, a storage device, and a communication device. In addition, the user terminal 20 can acquire the position of the user who possesses the user terminal 20 on the basis of a signal from Global Navigation Satellite System (GNSS).

The provider terminal 30 is operated by a food provider. The provider terminal 30 is, for example, a smartphone or a tablet personal computer. The provider terminal 30 includes a processor, a storage device, and a communication device. The food provider provides the food. As used herein, “food” includes foodstuffs, cooked dishes, and beverages. Food providers are, for example, restaurants and retailers (e.g., supermarkets or convenience stores).

The food supplier has “normal (in other words, main) provision form” and “temporary provision form” as the provision form of the food. In the example of a restaurant, provision of food (provision of eating and drinking) in a store corresponds to “normal provision form”. The food product more particularly includes, for example, at least one of a food and a beverage. In the case of a retailer, the provision (sale) of foodstuffs and dishes and beverages for takeout in a store corresponds to a “normal provision form”.

“Temporary form of provision” is a form that provides a food product that is no longer suitable for provision in a normal form of provision. In an example of a restaurant such as a restaurant, for example, the provision of food (for example, the food or beverage itself related to the cancellation, the foodstuff of the food or the beverage, or the material of the beverage) that is left in the restaurant due to the cancellation of the reservation of the restaurant according to the normal provision form corresponds to the “temporary provision form”. More specifically, the term “excess food” as used herein refers to a food determined by a food supplier to be difficult to consume within a consumption period in a normal provision form, for example, because a reservation has been cancelled. In other words, “excess food” refers to food that is expected to be discarded.

In addition, the “temporary provision form” may provide a food product having a short consumption date and/or an expiration date compared to a food product handled in a normal provision form. For example, a form in which a retailer provides a food product that is the same as that handled in a normal provision form but has a short expiration date corresponds to a “temporary provision form”.

In addition, the “food” subject to the “provisional form of provision” includes food that is damaged if not consumed early. That is, the “food” that is the object of the “temporary form of provision” is, for example, fresh food (for example, vegetables and fruits, fresh fish, and meat), cooked food, and the like. Further, the “temporary provision form” may include a retailer providing the above-described “surplus food” at a lower price than the normal provision form. Further, the price of the food provided in the “temporary provision form” may be set so as to decrease each time a predetermined time elapses from the start of the offer of the food.

The server 40 is interposed between the user terminal 20 and the provider terminal 30. The server 40 is a computer that executes various kinds of processing in the system 10 as will be described later. In other words, the server 40 is a management server. Specifically, the server 40 includes a communication device 42, a processor 44, and a storage device 46. The server 40 (communication device 42) is connected to each of the user terminal 20 and the provider terminal 30 via the communication network 1 such as wireless communication. The processor 44 executes the various processes described above. The storage device 46 stores various types of information. Examples of the storage device 46 include volatile memory, non-volatile memory, Hard Disk Drive (HDD), and Solid State Drive (SSD). When the processor 44 executes various computer programs, various kinds of processing by the processor 44 are realized. The various programs are stored in the storage device 46 or recorded in a computer-readable recording medium. Note that a plurality of processors 44 and storage devices 46 may be provided.

### 2. Processing in the System

### 2-1. Creating a Route Plan

The route plan generation system 10 generates a route plan for the user to move using MaaS. In the present embodiment, the processing related to the generation of the route plan is executed by the server 40 (the processor 44) as an example.

Specifically, the user operates the user terminal 20 to activate a predetermined application (MaaS application). The user inputs information necessary for generating a route plan such as a departure point, a departure time, a destination, a desired arrival time of the destination, and one or a plurality of via points (stop points). The input information is stored in the storage device 46 of the server 40.

In order to generate a route plan, a route plan information database is stored in the storage device 46 of the server 40. The route planning information database stores various pieces of information that form the basis for generating the route planning. The various pieces of information stored in the route planning information database are, for example, various types of traffic information such as road traffic information and route information, various types of map information such as road maps and route maps, information on various tourist spots, and information on various types of stores (for example, restaurants).

The server 40 (processor 44) executes a predetermined route search algorithm. Accordingly, the server 40 generates a route plan based on the information input by the user and the information in the route plan information database. The generated route plan is transmitted from the server 40 to the user terminal 20 via the communication network 1. The transmitted route plan is displayed on the screen of the user terminal 20. More specifically, the generated route plan includes, for example, a travel route from a departure point including one or more waypoints to a destination, an expected arrival time of each of the one or more waypoints and the destination, a moving device of each section of the travel route, a required time of each section of the travel route, and a time required for the transfer of the moving device. The moving device includes, for example, a moving body such as an autonomous vehicle, a train, a bus, a taxi, and a rental car, and a walk.

Note that the above-described process related to the generation of the route plan may be executed by (the processor of) the user terminal 20. Alternatively, the process related to the generation of the route plan described above may be executed by cooperation of the server 40 and the user terminal 20.

### 2-2. Matching Food Providers With Users

The server 40 (processor 44) executes processing related to matching between a food provider and a user who wishes to obtain (purchase) the food. The food supplier desires to provide the food using the above-described “provisional form of provision”. More specifically, the server 40 performs matching between the user and the food providing source for which the use registration of the application (matching application) for the matching has been completed. The matching app is integrated with, for example, a MaaS app for generating a route plan. These applications may be configured separately. The integration of these applications improves user convenience.

The storage device 46 of the server 40 stores a matching information database that stores information for the matching. The information stored in the matching information database includes a user information UI and a provider information PI. The user information UI includes personal information (for example, a name and an e-mail address) that identifies the user. The provider information PI includes information specifying a food provider (for example, location information such as a name and a location of a food provider, and an e-mail address).

The servers 40 receive the food information along with the provider information PI from the food supplier who wishes to match the food information via the communication network 1. The food information is information on the food pertaining to the offer of provision in the form of temporary provision. The food information includes, for example, at least one of a name, a quantity, an expiration date, and an expiration date of the food, and a place for providing the food. The food providing place is, for example, a store of a food providing source. Further, the food information may include, for example, information described later (information on vibration constraints and temperature conditions of the food, and information on a request for antimicrobial treatment).

The servers 40 that have received the food information together with the provider information PI provide the food information and the provider information PI (i.e., “offers for providing food in a temporary providing form from the food provider”) to the user. The provision target of the information may be, for example, all users of the matching app. Alternatively, the provision target of the information may be only a user who is located within a predetermined distance range from the provision location of the food by the food providing source. The provision of the food information and the provider information PI to the user can be performed, for example, by allowing the user to search for the food information and the provider information PI on the matching application, or by transmitting the food information and the provider information PI to the user by using a method such as an electronic mail or a message.

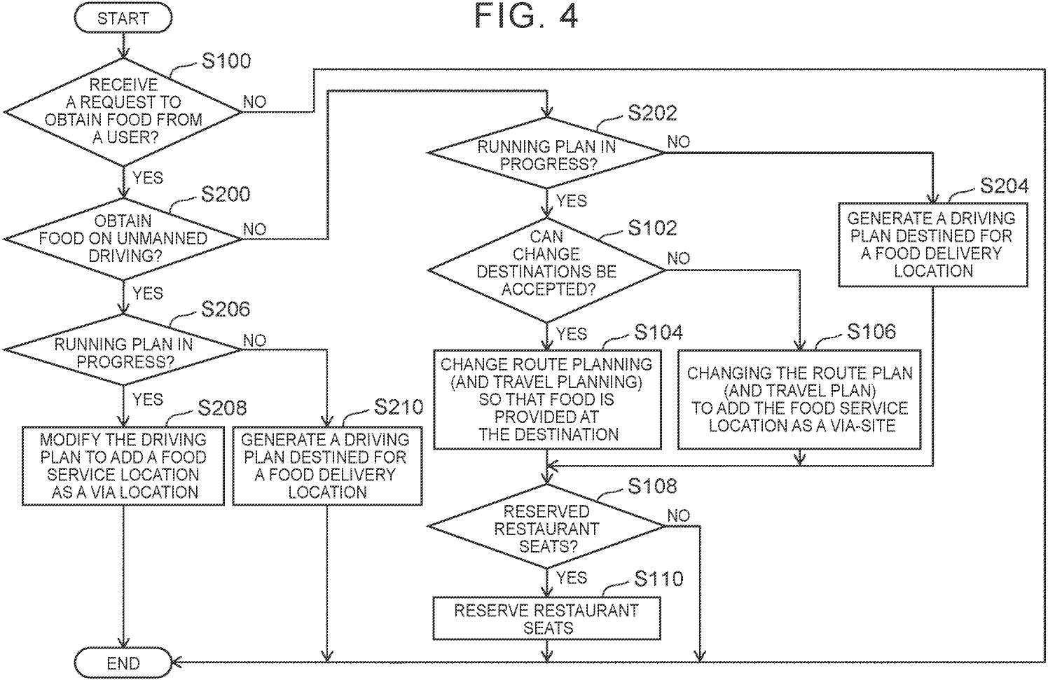

When the user desires to obtain the food pertaining to the offer upon receiving the offer from the food provider, the user operates the user terminal 20 to transmit information requesting the acquisition of the food to the server 40. Specifically, for example, the user executes a process of reserving the food on the matching application. The user may also make an approval of the food at the time of the reservation. The decision may be made when the food is actually obtained (for example, when receiving the food or when eating or drinking in a restaurant). As will be described later with reference to FIG. 4, the food may be received by using an automated driving vehicle capable of performing unmanned travel, which is an exemplary moving unit of MaaS.

After the reservation is completed, the server 40 transmits the information of the user who has completed the reservation to the food providing source. The information of the user transmitted to the food provider includes, together with the user information UI described above, an expected time at which the user arrives at the food provider location, for example, for obtaining food (e.g., receiving or eating and drinking).

In addition, a food providing source that provides information to the user via the server 40 on the matching application may be selected, for example, as follows. That is, in a case where the movement of the user is a travel for tourism, the input information of the user used for generating the route plan includes travel plan information such as a desired stop place and destination. Therefore, the server 40 may sort the food providing sources that provide information to the user on the matching application in accordance with the travel plan information of the user. Specifically, the server 40 may, for example, select food information of a food provider that handles foods that are deeply related to the travel area of the user identified from the travel plan information (for example, a product or a special product of the travel area), and provide the food information to the user. More specifically, for example, if the traveling area of the user is an area close to the sea, the server 40 may sort out the food information of the food provider that handles the seafood related to the area. If the travel area of the user is an area close to the mountain, the server 40 may sort out the food information of the food provider that handles the terrestrial product related to the area.

### 2-3. Route Plan Change Processing

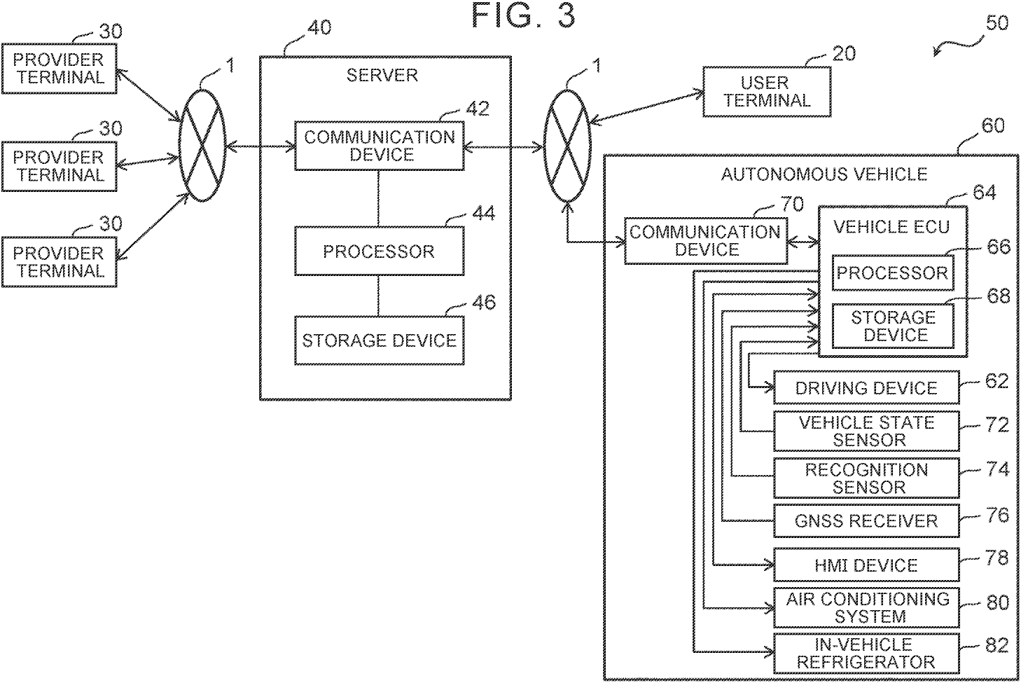

In a case where the user requests the user to obtain the food pertaining to the offer of the food in response to the offer of the food in the temporary offer form from the food provider, the system 10 executes the “route plan change process”. The route plan change process automatically changes the route plan for the user’s movement so that the place where the food pertaining to the offer is provided is the destination or the route. In the present embodiment, the route plan change process is executed by the server 40 (the processor 44). However, the route plan change processing may be executed by the user terminal 20 or by cooperation between the server 40 and the user terminal 20. In addition, when the user uses the autonomous driving vehicle as the moving unit, the device (for example, the vehicle ECU 64, the communication device 70, and HMI device 78 shown in FIG. 3 described later) mounted on the autonomous driving vehicle corresponds to another example of the “user terminal” in a broad sense.

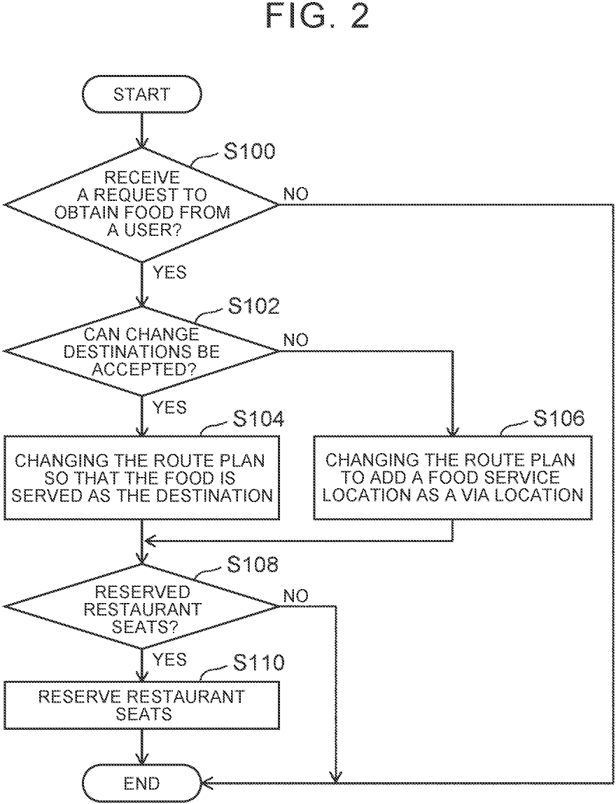

FIG. 2 is a flowchart illustrating an example of a route plan change process and a process related thereto according to the embodiment. The processing of this flowchart is performed during the execution of the route plan for the movement of the user.

In a S100 of steps, the server 40 (processor 44) determines whether a request to obtain food has been received from the user. This request is a request from a food supplier to obtain food pertaining to a request for provision in a temporary form. The result of this determination is affirmative, for example, when the server 40 receives information requesting acquisition of the food through the user terminal 20.

When the determination result of S100 of steps is negative (when a request for obtaining food is not received), the process of this flow chart ends. On the other hand, when the determination result is affirmative (when a food acquisition request is received), the process proceeds to step S102.

In a S102 of steps, the server 40 determines whether the user can accept the destination change. This determination can be performed, for example, as follows. That is, the server 40 transmits, to the user terminal 20, a notification for confirming whether or not to change the destination included in the route plan from the current destination to the food providing location. If the user’s reply to the notification accepts the change of destination, the result of the determination is affirmative. When the user’s response to the notification does not accept the change of the destination, the result of the determination is negative.

If the determination of the step S102 is affirmative (if the user is able to accept the destination change), the process proceeds to step S104. In S104 of steps, the servers 40 change the route planning so that the food providing location (for example, the store of the food providing source) is the destination.

On the other hand, when the determination result of the step S102 is negative (when the user is unable to accept the change of the destination), the process proceeds to the step S106. In S106 of steps, the servers 40 change the route planning so as to add the food providing location as a waypoint without changing the destination.

In the step S108 following the step S104 or S106, the server 40 determines whether or not the seat of the restaurant needs to be reserved. In the example in which the food provider who offered food provision is a restaurant, if the server 40 confirms that the user wants to reserve a seat of the restaurant via the user terminal 20, the result of this determination is affirmative. On the other hand, when the server 40 confirms through the user terminal 20 that there is no request for reservation of the seat of the restaurant, the determination result is negative. Alternatively, when the food provider is other than the restaurant, the determination result is negative.

When the determination result of the step S108 is affirmative (when the seat of the restaurant needs to be reserved), the process proceeds to the step S110. In the step-wise S110, the server 40 executes a process related to the reservation of the seat with the food provider via the provider terminal 30. On the other hand, when the determination of S108 of steps is negative (when the seat of the restaurant does not need to be reserved), the process of this flow chart ends.

### 3. Effect

As described above, according to the route plan generation system 10 of the present embodiment, when the user requests the provision of the food pertaining to the offer of the provision in response to the offer of the food in the temporary provision form from the food providing source, the route plan for the movement of the user is automatically changed so that the provision place of the food pertaining to the offer of the provision is the destination or the via point. Accordingly, it is possible to reduce the time and effort of the user regarding the route change that occurs when the user accepts the offer of the food provision from the food provider during the movement using the route plan. In other words, it is possible to realize matching between a food provider who desires to provide a food in the “temporary provision form” and a user who desires to obtain the food during use of the route plan, while reducing the user’s effort related to the route change. This leads, for example, to a reduction in food loss due to the user taking in the food that is likely to be discarded.

### 4. Examples of Use of Unmanned Vehicles

As described above, the moving device (moving body) included in the route plan may include an autonomously travelable vehicle. Then, the “route plan change process” may include setting a travel plan of the autonomous driving vehicle so that the autonomous driving vehicle goes to the food providing place in the unmanned driving when the user requests the acquisition of the food pertaining to the offer of the provision while the user is using the autonomous driving vehicle capable of unmanned traveling for the movement using the route plan.

FIG. 3 is a diagram illustrating another example of the configuration of the route plan generation system according to the embodiment. The route plan generation system 50 shown in FIG. 3 is different from the route plan generation system 10 shown in FIG. 1 in the points described below.

Specifically, the system 50 includes an autonomous vehicle (hereinafter, sometimes simply referred to as “vehicle”) 60 together with the user terminal 20, the provider terminal 30, and the server 40. The vehicle 60 is selected as a device of movement of the user in a route plan for movement of the user, and is used by the user.

The vehicle 60 includes a driving device, hereinafter a traveling device 62, an in-vehicle electronic control unit (vehicle ECU) 64, communication device 70, vehicle status sensor 72, recognition sensor 74, and Global Navigation Satellite System (GNSS) receiver 76, a Human Machine Interface (HMI device 78, an air conditioner 80, and an in-vehicle refrigerator 82.

The traveling device 62 includes, for example, a driving device, a braking device, and a steering device as devices that accelerate, decelerate, and steer the vehicle 60. The drive device includes, for example, at least one of an electric motor and an internal combustion engine, and drives wheels of the vehicle 60. The braking device applies a braking force to the vehicle 60. Steering equipment steers the wheels.

The vehicle ECU 64 is a computer that controls the vehicle 60. Specifically, the vehicular ECU 64 includes a processor 66 and a storage device 68. The processor 66 executes various processes. The various processes include processes related to automatic driving control of the vehicle 60, and processes illustrated in FIGS. 4 to 8 described later or processes related thereto, for example. The storage device 68 stores various types of information. Examples of the storage device 68 include volatile memory, non-volatile memory, Hard Disk Drive (HDD), and Solid State Drive (SSD). When the vehicle ECU 64 (processor 66) executes various computer programs, various processes by the vehicle ECU 64 are realized. The various programs are stored in the storage device 68 or recorded in a computer-readable recording medium. Note that a plurality of processors 66 and a plurality of storage devices 68 may be provided.

The communication device 70 includes a processor. The communication device 70 communicates with each of the user terminal 20, the provider terminal 30, and the server 40 via the communication network 1. The vehicle state sensor 72 detects a state of the vehicle 60. Examples of the vehicle state sensor 72 include a vehicle speed sensor, a steering angle sensor, a yaw rate sensor, and a lateral acceleration sensor. The recognition sensor 74 recognizes (detects) a situation around the vehicle 60. Examples of the recognition sensors 74 include cameras, Laser Imaging Detection and Ranging (LIDAR) sensors, and radars. GNSS receiver 76 obtains the position and orientation of the vehicles 60 based on the signals from GNSS.

HMI device 78 includes, for example, a touch panel and a speaker. HMI device 78 cooperates with the user terminal 20, for example. HMI device 78 may be configured to be able to use the above-described integrated application of MaaS application and the matching application, or each of MaaS application and the matching application. That is, when HMI device 78 cooperates with the user terminal 20 (for example, a smart phone), HMI device 78 (and the vehicle ECU 64 and the communication device 70) corresponds to a “user terminal” in a broad sense. The air conditioner 80 controls the temperature (vehicle cabin temperature) of the interior of the vehicle 60 based on a command from the vehicle ECU 64. The in-vehicle refrigerator 82 is installed in the vehicle cabin and operates based on a command from the vehicle ECU 64.

FIG. 4 is a flowchart illustrating another example of a route plan change process and a process related thereto according to the embodiment. FIG. 4 shows a process executed during execution of the route plan, with the object being when the user is using the vehicle 60 capable of unmanned traveling as the moving device. The processing illustrated in FIG. 4 is basically executed by the server 40 (the processor 44). However, at least a part of the process illustrated in FIG. 4 may be executed by at least one of the user terminal 20 and the vehicular ECU 64.

In FIG. 4, when the determination result of the step S100 is affirmative (when a food acquisition request is received), the process proceeds to the step S200. In the step-wise S200, the server 40 determines whether or not there is a demand to obtain the food pertaining to the offer by using the unmanned travel of the vehicle 60. For example, when the server 40 communicates with the user terminal 20 and receives information indicating the request from the user, the result of the determination is positive. When information indicating that unmanned travel is not to be used is received from the user, the result of the determination is negative.

When the determination result of the step S200 is negative (when unmanned travel is not used), the process proceeds to step S202. In the step-wise S202, the server 40 determines whether or not the travel plan of the vehicle 60 is being executed. Here, the “travel plan” is set according to the “route plan” for the movement of the user generated by the system 50. The “travel plan” includes, for example, a travel route and a travel speed of the vehicle 60. The vehicle ECU 64 executes travel control so that autonomous driving of the vehicle 60 is performed in accordance with the travel plan.

When the driving plan is being executed in the step S202, the server 40 executes S110 process from the step S102 as described with reference to FIG. 2. In addition, when the “route plan” is changed by the process of the step S104 or S106, the travel plan of the vehicles 60 is similarly changed in association with the change of the route plan. That is, in the travel planning, the destination is changed to a food providing place (step S104), or a food providing place is added as a transit place (step S106).

On the other hand, when the determination result of the step S202 is negative (when the travel plan according to the route plan is not generated), the process proceeds to the step S204. In S204 of steps, the servers 40 generate a travel plan of the vehicles 60 whose destinations are the food providing locations. In accordance with this, the route plan of the user is also changed so that the food providing place is, for example, a via place.

If the determination result of step 200 is affirmative (when unmanned travel is used), the process proceeds to step S206. In the step S206, the server 40 determines whether or not the travel plan of the vehicle 60 (more specifically, the travel plan for performing the unmanned travel for another purpose that is not the obtainment of the food pertaining to the offer of the step S100) is being executed.

If the driving plan is being executed in the step S206, the process proceeds to the step S208. In S208 of steps, the server 40 changes the travel plan so as to add a food providing location as a waypoint.

On the other hand, when the determination result of the step S206 is negative (when the travel plan is not generated), the process proceeds to the step S210. In S210 of steps, the servers 40 generate a travel plan of the vehicles 60 whose destinations are the food providing locations.

In addition, the server 40 causes the vehicle ECU 64 to execute the travel plan changed or generated by the process of the flow chart shown in FIG. 4. Consequently, according to the travel plan, the vehicle ECU 64 executes travel control so that the vehicle 60 travels to receive the food in unmanned travel.

The time period during which the user executing the route plan is selecting the vehicle 60 as the moving device may include a time period during which the user is not using the vehicle 60 (more specifically, a time period during which the user is not on the vehicle 60 for the purpose of the movement), for example, because the user is stopping at some facility during the sightseeing. According to the processing of the flowchart illustrated in FIG. 4 described above, the food can be received by using the vehicle 60 that performs unmanned travel in such a time period. Therefore, the food can be obtained while effectively utilizing the travel time of the user during execution of the route plan.

### 5. Examples of Accompanying Processing

When the user executing the route plan uses an autonomously travelable autonomous vehicle (for example, the vehicle 60) as the moving device, the following processing may be executed in association with the route plan change processing according to the above-described embodiment.

### 5-1. Services Offered While Riding When Bringing Food

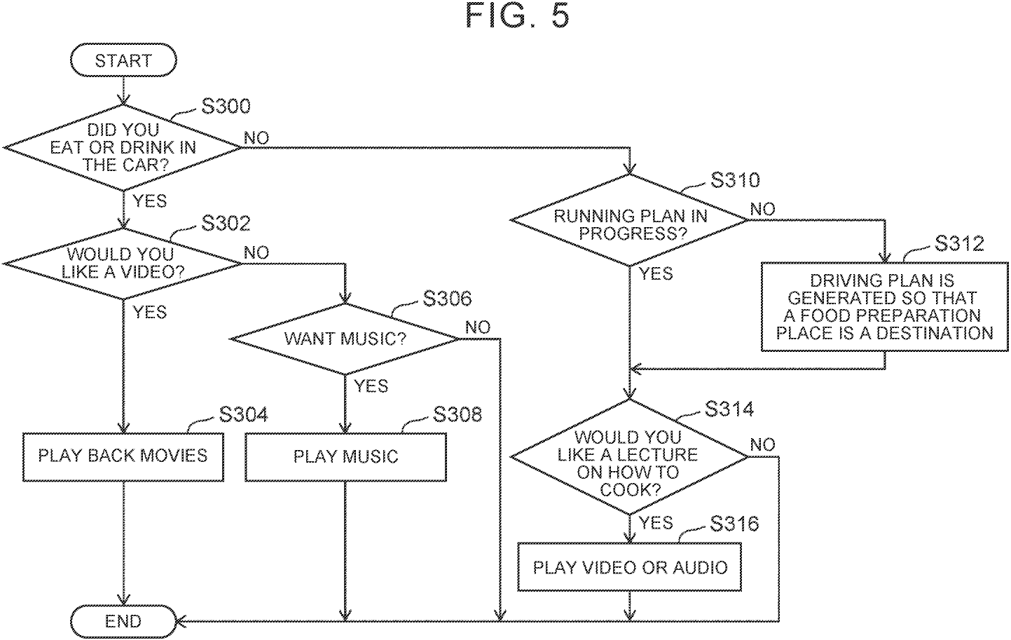

FIG. 5 is a flowchart illustrating a process related to a service provided during a user’s boarding when bringing food. When the user brings the food back without eating and drinking at the restaurant, the determination of S108 of steps in FIG. 4 is negative. In addition, even in an example in which the food provider is other than the restaurant (for example, the retailer’s store), since the user brings the food home, the determination result becomes negative. The process illustrated in FIG. 5 is executed when the determination result of the step S108 in FIG. 4 is negative as described above.

The processing illustrated in FIG. 5 is executed, for example, during a ride after receiving the food at the providing place (during takeout of the food). However, processing similar to the processing may be performed, for example, on the road where the user gets into the vehicle 60 and goes to the food providing place. The execution subject of the processing illustrated in FIG. 5 is not particularly limited as long as it is a component of the system 50. For example, the execution subject of the processing illustrated in FIG. 5 is the user terminal 20. The process illustrated in FIG. 5 may be executed by, for example, cooperation between the user terminal 20 and HMI device 78, cooperation between the user terminal 20 and the servers 40, or cooperation between the user terminal 20 and the vehicular ECU 64. Further, the processing illustrated in FIG. 5 may be executed when the user is on a rental car, for example, instead of the autonomous driving vehicle such as the vehicle 60.

In FIG. 5, in a step-wise S300, the user terminal 20 (the processor of the user) determines whether the user desires to eat or drink the received food (e.g., lunch box) in the vehicle based on the response from the user to the notification to the user. Consequently, if the user wishes to eat and drink in the vehicle (step S300; Yes), the process proceeds to step S302.

In the step-wise S302, the user terminal 20 determines whether or not the user desires to view the video related to the received food information, based on the response from the user to the notification to the user. Consequently, if the user wishes to view the video, the process proceeds to step S304. In the step S304, the user terminal 20 executes a process related to reproduction of the moving image. In an example in which the user terminal 20 is a smartphone, the moving image may be played back using a screen of the smartphone. Alternatively, the moving image may be played back using the display of HMI device 78 of the vehicle 60.

On the other hand, if the user does not wish to view the moving image in the step S302, the process proceeds to the step S306. In the step-wise S306, the user terminal 20 determines whether or not the user desires to view the music, based on the response from the user to the notification to the user. Consequently, if the user wishes to view the music, the process proceeds to step S308. In the step-wise S308, the user terminal 20 executes a process related to the reproduction of the music. The music may be played back using, for example, a speaker of a smart phone that is the user terminal 20, or using a speaker included in HMI device 78. If the user does not wish to view the music, the process of this flowchart ends.

If the user does not wish to eat or drink in the vehicle in the step S300 (for example, if the food to be received is food material), the process proceeds to the step S310. In the step S310, the user terminal 20 determines whether or not the travel plan of the vehicle 60 is being executed.

In a case where the travel plan is not being executed in the step S310 (that is, a case where the food providing location is the destination), the process proceeds to the step S312. In the step-wise S312, the user terminal 20 generates a travel plan of the vehicles 60 whose destinations are the cooking locations of the foodstuffs. Along with this, the route plan of the user is also changed so that the cooking place is, for example, the destination. Thereafter, the process proceeds to step S314.

On the other hand, when the traveling plan is being executed in the step S310 (that is, when the food providing location is a transit location included in the traveling plan being executed), the process proceeds to the step S314.

In the step-wise S314, the user terminal 20 determines whether or not a lecture on how to cook the foodstuff to be taken back is desired based on the response from the user to the notification to the user. Consequently, if the user desires the lecture, the process proceeds to step S316. In S316 of steps, the user terminal 20 executes a process of reproducing a moving image or sound related to the lecture. The video or audio may be reproduced using, for example, a smart phone that is the user terminal 20, or using HMI device 78. If the user does not wish to have the lecture, the process of this flowchart ends.

According to the processing of the flowchart illustrated in FIG. 5 described above, it is possible to provide a service for transmitting information on the food to the user by using the travel time of the user for receiving the food.

### 5-2. Consideration for Food During Unmanned Travel

### 51. Vibration Countermeasures

The food taken from the food provider may include food that is susceptible to vibrations occurring in the vehicle cabin while the vehicle 60 is running, such as soup or cake. Therefore, it is desirable to satisfy the vibration constraint of the food to suppress the leakage or the bias of the food during the transportation of the food by the unmanned travel depending on the food to be carried.

Therefore, in a case where the vibration restriction is present, when the vehicle 60 performs the unmanned travel and brings the food pertaining to the offer of provision, the system 50 satisfies the vibration restriction. In order to satisfy the vibration constraint, the system 50 may cause the vehicle 60 to execute at least one of vehicle control (vibration suppression control) and travel route selection (selection of a vibration suppression route) for suppressing vibration of the vehicle cabin of the vehicle 60.

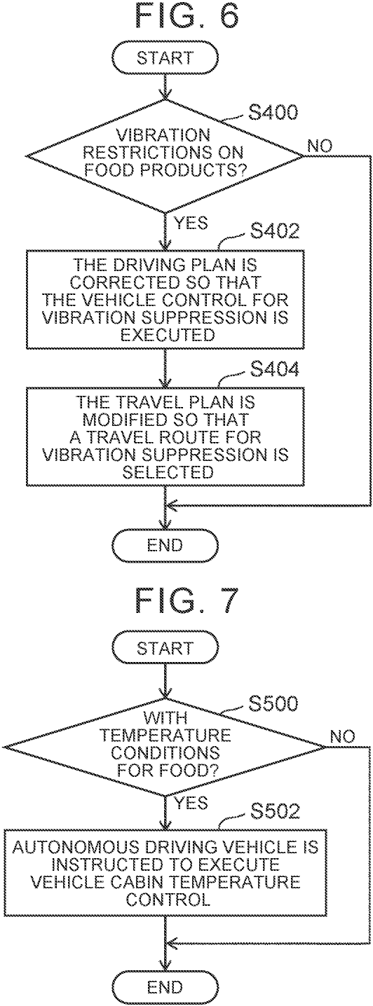

FIG. 6 is a flowchart illustrating a process related to a countermeasure against vibration of a food product during unmanned travel and takeout. The processing illustrated in FIG. 6 is executed by the server 40, for example. However, the process illustrated in FIG. 6 may be executed by the user terminal 20 or the vehicular ECU 64. The process illustrated in FIG. 6 is executed after the process of step S208 or step S210 in FIG. 4.

In a S400 of steps, the servers 40 determine whether there is a vibratory constraint on the food. The vibration constraint is included in the above-described food information transmitted from the food provider, for example.

If there is no food vibrational constraint in S400 of steps, the process of this flow chart ends. On the other hand, if the oscillation constraint is present, the process proceeds to step S402.

In the step S402, the servers 40 modify the travel regime changed or generated in the step S208 or S210 so that “vehicle control for vibration-suppression of the vehicle cabin” is performed when the unmanned travel is performed to take food. Consequently, the vehicle ECU 64 that controls the travel of the vehicle 60 in accordance with the travel plan executes the vehicle control when the vehicle is performing the unmanned travel in order to take the food.

More specifically, the “vehicle control” referred to here is, for example, the following “acceleration/deceleration control”. The acceleration/deceleration control is a control for suppressing the rapid acceleration and the rapid deceleration of the vehicle 60. The acceleration/deceleration control includes, for example, setting an upper limit value of each of the acceleration and deceleration of the vehicle 60, and controlling the traveling device 62 so that each of the acceleration and the deceleration does not exceed the upper limit value. In addition, the acceleration/deceleration control may set the traveling speed of the vehicle 60 in a case where there is a vibration restriction lower than in a case where there is no vibration restriction. In the step S402, the server 40 modifies the travel plan such that at least one of the setting of the upper limit of the acceleration/deceleration and the setting of the travel speed is reflected in the travel plan.

In addition, the “vehicle control” may be at least one of a suspension control, a EV travel control, and a four-wheel drive travel control in place of or together with the acceleration/deceleration control. The suspension control is, for example, a ski hook control using an active suspension. In the case where the vehicle 60 is a hybrid electric vehicle (HEV), EV traveling control performs unmanned traveling in order to bring the food by the driving force of only the electric motor. In the four-wheel drive travel control, in an example in which the vehicle 60 is configured to be capable of switching between the two-wheel drive and the four-wheel drive, the four-wheel drive performs the unmanned travel when the food is carried back.

In the step S404, the servers 40 modify the travel schedule changed or generated in the step S208 or S210 so that the “travel route selection for vibration-suppression of the vehicle cabin” is executed. Consequently, the vehicle ECU 64 that controls the travel of the vehicle 60 in accordance with the travel plan executes the travel route selection while the vehicle is performing the unmanned travel in order to take the food. The “travel route selection” referred to here includes, for example, selecting a travel route so as to avoid a travel route including a travel route having a large unevenness on a road surface and a steep gradient even if the travel route becomes long.

In FIG. 6, processing for causing both “vehicle control” and “travel route selection” to be executed is executed. Instead of this example, a process for causing only one of “vehicle control” and “travel route selection” to be executed may be executed.

According to the vibration countermeasure described above, it is possible to suppress the vibration of the vehicle cabin so as to satisfy the vibration constraint of the food when the vehicle 60 performs the unmanned travel in order to take the food. As a result, it is possible to suppress the leakage or the bias of the food material even during the unmanned takeout of the food.

### 52. Temperature Control

Foods brought from food providers may include foods where it is desirable to properly maintain the temperature of the foods. In addition, the food to be taken back may include a food that needs to be thawed during cooking in order to be provided in a frozen state. Therefore, it is desirable to be able to control the temperature of food during transportation of the food by unmanned traveling depending on the food to be carried.

Therefore, when there is a predetermined temperature condition for the food related to the offer of provision, the system 50 may cause the vehicle 60 to execute the vehicle cabin temperature control of the vehicle 60 according to the temperature condition when the vehicle 60 performs the unmanned travel and brings back the food related to the offer of provision.

FIG. 7 is a flowchart illustrating a process related to temperature management of food during unmanned travel and takeout. The process illustrated in FIG. 7 is executed by the servers 40, for example, but may be executed by the user terminals 20 or the vehicular ECU 64. The process illustrated in FIG. 7 is executed after the process of step S208 or step S210 in FIG. 4.

In S500 of steps, the server 40 determines whether or not there is a temperature-condition of the food. This temperature condition includes, for example, maintaining the food at an appropriate temperature (a predetermined temperature range) and requiring thawing of the food prior to cooking. The temperature condition is included in the above-described food information transmitted from the food providing source, for example.

If there is no food temperature condition at the step S500, the process of this flowchart is completed. On the other hand, if there is such a thermal condition, the process proceeds to S502 of steps.

In S502 of steps, the servers 40 instruct the vehicles 60 (vehicle ECU 64) to execute “vehicle cabin temperature control” when the unmanned driving is performed in order to take the food. As a consequence, the vehicle ECU 64 executes the vehicle cabin temperature control while performing the unmanned travel in order to take the food.

More specifically, the “vehicle cabin temperature control” described here is performed by, for example, control of the air conditioner 80. In the vehicle cabin temperature control, the vehicle ECU 64 sets the target vehicle cabin temperature according to the temperature condition, for example, on the basis of the “appropriate temperature of the food” included in the food information and the time required for bringing the food back (that is, time required for moving to the current position of the user as the destination)). Specifically, the target vehicle cabin temperature is set to be, for example, a vehicle temperature suitable for keeping the food at an appropriate temperature, or a vehicle cabin temperature suitable for thawing the food. Then, the vehicle ECU 64 controls the air conditioner 80 such that the vehicle cabin temperature detected by the temperature sensor approaches the target vehicle cabin temperature.

According to the temperature control described above, when the vehicle 60 is performing the unmanned travel in order to take the food, the vehicle cabin temperature is controlled in accordance with the temperature condition of the food. This makes it possible to maintain the food during transportation at an appropriate temperature (warm, cold, or frozen) or to thaw the food using the time during transportation.

### 53. Antimicrobial Measures

It is conceivable that a food provider or a user may request an antimicrobial treatment of a food when the food is taken back by using the unmanned travel of the vehicle 60. Therefore, when there is a request for antimicrobial treatment of food, the system 50 may automatically activate the in-vehicle refrigerator 82 that stores the food when the vehicle 60 performs unmanned driving and brings back the food pertaining to the offer of provision.

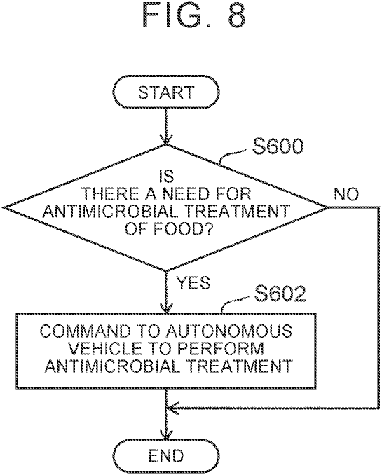

FIG. 8 is a flowchart showing a process related to an antibacterial measure of food being carried out in an unmanned travel. The processing illustrated in FIG. 8 is executed by the server 40, for example. However, the process illustrated in FIG. 8 may be executed by the user terminal 20 or the vehicular ECU 64. The process illustrated in FIG. 8 is executed after the process of step S208 or step S210 in FIG. 4.

In a S600 of steps, the servers 40 determine whether there is a demand for antimicrobial treatment of the food from the food provider or the user. This request is included, for example, in the above-described food information transmitted from the food provider. Alternatively, the request is included in the information indicating the above-described acquisition request transmitted from the user. Note that the information transmitted from the server 40 to the food providing source after the reservation of the food by the user on the matching application is completed may include information indicating that the vehicle 60 is provided with the in-vehicle refrigerator 82, and information requesting the food providing source to place the food in the in-vehicle refrigerator 82 in the case of the food requiring the antimicrobial treatment.

When there is no demand for antimicrobial treatment of food in the step S600, the process of this flow chart ends. On the other hand, if there is a need for an antimicrobial treatment, the treatment proceeds to step S602.

In S602 of steps, the servers 40 instruct the vehicle 60 (vehicle ECU 64) to operate the in-vehicle refrigerator 82 while the vehicle is running unmanned to take food. As a consequence, the vehicle ECU 64 activates the in-vehicle refrigerator 82 during unmanned travel to bring food back.

According to the antimicrobial measures described above, when the vehicle 60 performs unmanned traveling in order to take the food, the antimicrobial measures (for example, maintaining the freshness of the fresh food) of the food can be performed in response to a request from the food providing source or the user.

What is claimed is:

1. A route plan generation system that generates a route plan for movement of a user, the route plan generation system comprising:
a user terminal operated by the user;
a provider terminal operated by a food provider, the food provider having a normal provision mode of food and a temporary provision mode, in which the temporary provision mode is a mode that provides food that is no longer suitable for provision in the normal provision mode; and
a server that is connected to the user terminal and the provider terminal via a communication network,
wherein when the user requests, in response to a provision offer of food in the temporary provision mode from the food provider, acquisition of the food pertaining to the provision offer, the route plan generation system executes a route plan change process of changing the route plan such that a provision place of the food pertaining to the provision offer is a destination or a transit point.

2. The route plan generation system according to claim 1, wherein in a case in which the user requests the acquisition of the food pertaining to the provision offer when the user is using an autonomous vehicle that is able to perform unmanned traveling as a moving body for the movement, the route plan change process further includes setting a travel plan of the autonomous vehicle such that the autonomous vehicle performs unmanned traveling to the provision place.

3. The route plan generation system according to claim 2, wherein in a case in which there is a vibration restriction of the food required during transportation of the food pertaining to the provision offer, when the autonomous vehicle performs unmanned traveling and brings back the food pertaining to the provision offer, the route plan generation system causes the autonomous vehicle to execute at least one of a vehicle control and a travel route selection for suppressing a vibration of a vehicle cabin of the autonomous vehicle.

4. The route plan generation system according to claim 2, wherein in a case in which there is a temperature condition of the food required during transportation of the food pertaining to the provision offer, when the autonomous vehicle performs unmanned traveling and brings back the food pertaining to the provision offer, the route plan generation system causes the autonomous vehicle to execute a vehicle cabin temperature control of the autonomous vehicle for satisfying the temperature condition.

5. The route plan generation system according to claim 2, wherein in a case in which the user or the food provider makes a request for antimicrobial treatment of the food pertaining to the provision offer, when the autonomous vehicle performs unmanned traveling and brings back the food pertaining to the provision offer, the route plan generation system operates an in-vehicle refrigerator that houses the food pertaining to the provision offer.

6. The route plan generation system according to claim 1, wherein:
the food provider is a restaurant that provides food in a store as the normal provision mode; and
the temporary provision mode is a mode in which excess food due to a reservation for eating and drinking in the restaurant is cancelled is provided.

7. A route plan generation method for generating a route plan for movement of a user, the route plan generation method comprising:
changing the route plan such that a provision place of food pertaining to a provision offer is a destination or a transit point, when the user requests acquisition of the food pertaining to the provision offer in response to the provision offer of the food in a temporary provision mode from a food provider, in which the food provider has a normal provision mode and a temporary provision mode of food, and in which the temporary provision mode is a mode in which food not suitable for the normal provision mode is provided.
